(19) United States
(12) Patent Application Publication
(10) Pub. No.: US 2018/0240053 A1
(43) Pub. Date: Aug. 23, 2018

(54) System and Method for Associating a Multi-segment Component Transaction

(71) Applicant: SHANGHAI NETIS TECHNOLOGIES CO., LTD., Shanghai (CN)

(72) Inventors: Xiaolin He, Shanghai (CN); Tao Wang, Shanghai (CN); Yuliang Zhou, Shanghai (CN); Guanghui Yang, Shanghai (CN)

(21) Appl. No.: 15/751,878

(22) PCT Filed: May 5, 2016
(86) PCT No.: PCT/CN2016/081058

§ 371 Date: Feb. 12, 2018

(30) Foreign Application Priority Data
Jan. 18, 2016 (CN) 201610031063.2

(51) Int. Cl. G06Q 10/06; G06F 17/30; G06F 17/18

(52) U.S. Cl. CPC G06Q 10/0639; G06F 17/18; G06F 17/30985; G06F 17/30952

(57) ABSTRACT

A method for associating a multi-segment component transaction includes generating transaction tracking records of each component; setting association filtering parameters of a transaction to be associated; filtering out transaction tracking records conforming to the association filtering parameters from the transaction tracking records of the starting point component; and filtering out transaction tracking records matching with the filtered starting point component from the transaction tracking records of the non-starting point component. The present invention solves the association problem that a number of front and rear components in the business link are used to process the same transaction, and accelerates the search time under the premise of ensuring the integrity and security of the association data; and the present invention can calculate and determine the associated transaction and make the complete statistics in real time and accurately.

### CROSS REFERENCE OF RELATED APPLICATION

This is a U.S. National Stage under 35 U.S.C 371 of the International Application PCT/CN2016/081058, filed May 5, 2016, which claims priority under 35 U.S.C. 119(a-d) to CN 201610031063.2, filed Jan. 18, 2016.

### BACKGROUND OF THE PRESENT INVENTION

### Field of Invention

The present invention relates to the field of performance monitoring, and more particularly to a system and method for associating a multi-segment component transaction. The present invention allows users to easily track the historical transaction information.

### Description of Related Arts

At present, the enterprises, especially large financial enterprises have a set of their own internal business performance management system to monitor their own business operations in real time.

In the enterprise business system, due to different types of businesses, the devices and processes for processing the transaction are not the same. In one example, as shown in FIG. 1, it is a typical process for business processing data request and response of an enterprise. In FIG. 1, a data processing request from the client passes through multiple components such as routers, firewalls, load balancers, web servers, middleware and databases; finally, each of these components returns the response messages of processing results to the client one by one.

In general, the business transaction consists of transaction request and transaction response. For a single component, a transaction is completed through the interaction of a request with a response. In the enterprise business performance management system, the required message data can be got through the data decoder and these data comprise the fields such as request time, response time, transaction type, transaction channel and return code, so that the business management department of the enterprise can easily monitor the processing results of each component for a request and response, that is, processing situations of a transaction.

However, with the development of the times, the change in business type and the rapid increase in business volume, the enterprises have increasingly high requirements for the system performance. The transaction monitoring of a single component has failed to meet the needs of enterprise business management department for monitoring of the whole business system. In fact, in the whole business link, each component has experienced the interaction process of the request and response for the same transaction. Since the purposes of each component to process the data are different, and the processing methods used and the message protocol specifications are different, the resulting message data are also different. Therefore, it is very difficult to associate the information of a transaction with the components of the whole business link. In the process of business monitoring, if it is required to monitor the whole business link, the statistics of transactions of all components shall be made, and then the results are got through the manual integration, which increases the difficulty of the enterprise for the overall business performance analysis and also restricts the development of core business data monitoring field of the whole enterprise.

The following relevant search results are found after retrieval

Relevant Search Result 1:

Application No.: 201410797686.1

Title: Method and System for Analyzing the Transaction Associativity Publication No.: CN104408584A

This patent documentation discloses a method for analyzing the transaction associativity, comprising exporting and storing the target transaction message; traversing a private message in the target transaction message for the first time and determining the split mode corresponding to the private message; after the end of the first traversal, splitting the private message in the target transaction message into a plurality of fragments, and the plurality of fragments constitute the fragment elements in the set of fragments of each transaction; performing the second traversal and splitting the corresponding private message by using the split mode in the set of the simplest split modes; performing the third traversal and comparing any two private messages by using the fragment elements in the set of fragments, and when the comparison results within two fragment elements meet the predetermined conditions, determining that the two transactions are associated; building the network diagram, and using the transaction as a node and the associativity between the transactions as a directed edge.

Comparison of Technical Essentials:

Although this patent documentation and the present invention have achieved the transaction association between the components, the technical means used are completely different. According to the method in the present invention, the multi-segment transaction association is achieved by determining the dependency between the components through wildcard fields and reasonably matching the association fields; while this patent documentation directly uses the way of dismantling the data message, so that it has shortcomings, such as long time and difficult matching.

Relevant Search Result 2:

Application No.: 201010538396.7

Title: Easily Expandable Method and System for Multi-level Classification Retrieval

Publication No.: CN102467521A

This patent documentation discloses an easily expandable method and system for multi-level classification retrieval and relates to the field of database retrieval technology. The method comprises setting the classification field in the data sheet based on the data classification information and storing the hierarchical relationship between the classification nodes; storing the association relationship between the data sheet and the classification field in the data sheet in the classification field association table; splitting each node into separate fields based on the hierarchical relationship between the classification nodes, and combining the separate fields with other fields in the data sheet, to generate a classification association table; when retrieving, retrieving the data in the classification association table by using the database index; when the classification field is added in the data sheet, automatically storing the association relationship between the added classification field and the data sheet in the classification field association table; and when the value is assigned to the added classification field, automatically summarizing all classification field values associated with the data sheet based on the association relationship in the classification field association table and writing the classification field values to the summary classification fields of the data sheet.

Comparison of Technical Essentials:

1. Similarity: In this patent documentation and the present invention, the association fields are matched accurately by way of database index;

2. Difference: This patent documentation adopts the method of directly indexing the association field table. The present invention adopts the method of translating the index through the binary table. The methods adopted are different and the effect of the present invention of the other is only a functional module in our invention.

### SUMMARY OF THE PRESENT INVENTION

In view of the defects in the prior art, an object of the present invention is to provide a system and method for associating a multi-segment component transaction.

A method for associating a multi-segment component transaction, provided by the present invention, comprises steps of:

generating transaction tracking records which comprises generating transaction tracking records of each component;

setting transaction information which comprises setting association filtering parameters of a transaction to be associated, wherein the association filtering parameters comprise a starting point component;

filtering out starting point component records which comprises filtering out transaction tracking records conforming to the association filtering parameters from the transaction tracking records of the starting point component; and

filtering out non-starting point component records which comprises filtering out transaction tracking records matching with the filtered starting point component from the transaction tracking records of a non-starting point component; wherein the filtered transaction tracking records of the starting point component and the non-starting point component are used as the associated multi-segment component transaction.

Preferably, the step of generating transaction tracking records comprises:

extracting association fields which comprises extracting the association fields from every component packet respectively;

performing wildcarding which comprises using the association field as wildcard fields, wherein a value of the wildcard fields is a wildcard;

generating transaction information which comprises associating a transaction request with a transaction response for each component and obtaining the transaction information, wherein the transaction information comprises a wildcard; and

obtaining the transaction tracking records which comprises obtaining the transaction tracking records for each component based on the transaction information.

Preferably, the association filtering parameters further comprises a search time range, a wildcard search value and a transaction delay threshold;

The step of filtering out starting point component records comprises:

a first filtering step which comprises storing transaction tracking records to conforming to a condition A of the starting point component in a cache and discarding transaction tracking records not conforming to the condition A of the starting point component, wherein the condition A comprises:
a request timestamp of the transaction request in the transaction tracking records is within the search time range;
the wildcard in the transaction tracking records is consistent with the wildcard search value; and
a transaction processing time in the transaction tracking records is less than the transaction delay threshold.

Preferably, the step of filtering out non-starting point component records comprises:

a second filtering step which is specifically as storing transaction tracking records conforming to a condition B of the non-starting point component in the cache and discarding transaction tracking records not conforming to the condition B of the non-starting point component, wherein the condition B comprises:
the wildcard in the transaction tracking records is consistent with the wildcard in the transaction tracking record of the starting point component;
the request timestamp of the transaction request in the transaction tracking records is later than the request timestamp of the transaction request in the transaction tracking records of the starting point component; and
the transaction processing time in the transaction tracking records is less than the transaction processing time in the transaction tracking records of the starting point component.

Preferably, the step of obtaining the transaction tracking records comprises:

generating an index number based on the wildcard, wherein the index number is a set of binary numbers;

generating an index table based on the index number, wherein the index table comprises a plurality of binary query tables and the set of binary numbers in the index number are distributed in the plurality of binary query tables,

wherein the transaction tracking records comprises the index number and the index table.

The second filtering step comprises:

performing index matching which comprises matching the index number in the transaction tracking records of the starting point component with the index table in the transaction tracking records of the non-starting point component based on a distribution position of the index number of the non-starting point component in the index table; if the matching is successful, it is believed that the wildcard in the transaction tracking records of the non-starting point component is consistent with the wildcard in the transaction tracking records of the starting point component; otherwise, the wildcard in the transaction tracking records of the non-starting point component is inconsistent with the wildcard in the transaction tracking records of the starting point component, wherein the transaction tracking records comprise at least one member selected from a group consisting of:
transaction time;
type; and
serial number.

A system for associating a multi-segment component transaction, provided by the present invention, comprises:

a transaction tracking record generation device which is adapted for generating transaction tracking records of each component;

a transaction information setting device which is adapted for setting association filtering parameters of a transaction to be associated, wherein the association filtering parameters comprise a starting point component;

a starting point component record filtering device which is adapted for filtering out transaction tracking records conforming to the association filtering parameters from the transaction tracking records of the starting point component; and

a non-starting point component record filtering device which is adapted for filtering out transaction tracking records matching with the filtered starting point component from the transaction tracking records of the non-starting point component,

wherein the filtered transaction tracking records of the starting point component and the non-starting point component are used as the associated multi-segment component transaction.

Preferably, the transaction tracking record generation device comprises:

an association field extraction device which is adapted for extracting association fields from each component packet respectively;

a wildcarding device which is adapted for using the association fields as wildcard fields, wherein a value of the wildcard fields is a wildcard;

a transaction information generation device which is adapted for associating a transaction request with a transaction response for each component to obtain transaction information, wherein the transaction information comprises the wildcard; and

a transaction tracking record obtaining device which is adapted for obtaining the transaction tracking records for each component based on the transaction information.

Preferably, the association filtering parameters further comprise a search time range, a wildcard search value and a transaction delay threshold.

The starting point component record filtering device comprises:

a first filtering device which is adapted for storing transaction tracking records conforming to a condition A of the starting point component in a cache and discarding transaction tracking records not conforming to the condition A of the starting point component, wherein the condition A comprises:
a request timestamp of the transaction request in the transaction tracking records is within the search time range;
the wildcard in the transaction tracking records is consistent with the wildcard search value; and
a transaction processing time in the transaction tracking records is less than the transaction delay threshold.

Preferably, the non-starting point component record filtering device comprises:

a second filtering device which is adapted for storing transaction tracking records conforming to a condition B of the non-starting point component in the cache and discarding transaction tracking records not conforming to the condition B of the non-starting point component, wherein the condition B comprises:
the wildcard in the transaction tracking records is consistent with the wildcard in the transaction tracking records of the starting point component;
the request timestamp of the transaction request in the transaction tracking records is later than the request timestamp of the transaction request in the transaction tracking records of the starting point component; and
the transaction processing time in the transaction tracking records is less than the transaction processing time in the transaction tracking records of the starting point component.

Preferably, the transaction tracking record obtaining device:

means for generating an index number based on the wildcard, wherein the index number is a set of binary numbers; and

means for generating an index table based on the index number, wherein the index table comprises a plurality of binary query tables and the binary numbers in the index number are distributed in the plurality of binary query tables,

wherein the transaction tracking records comprises the index number and the index table.

The second filtering device comprises:

an index matching device which is adapted for matching the index number in the transaction tracking records of the starting point component with the index table in the transaction tracking records of the non-starting point component based on a distribution position of the index number of the non-starting point component in the index table; if the matching is successful, it is believed that the wildcard in the transaction tracking records of the non-starting point component is consistent with the wildcard in the transaction tracking records of the starting point component; otherwise, the wildcard in the transaction tracking records of the non-starting point component is inconsistent with the wildcard in the transaction tracking records of the starting point component,

wherein the transaction tracking record comprises at least one member selected from a group consisting of:
transaction time;
type; and
serial number.

Compared with the prior art, the present invention has the following beneficial effects:

1. The present invention solves the association problem that a number of front and rear components in the business link are used to process the same transaction, and accelerates the search time under the premise of ensuring the integrity and security of the association data;

2. The present invention has little occupation of system resources, which does not affect the transmission of data information and the performance of the business monitoring system, and can calculate and determine the associated transaction and make the complete statistics in real time and accurately.

3. According to the present invention, the association of front and rear components for the same transaction is achieved in the association field wildcarding way, with a high association accuracy; wherein the statistics of association transaction between the components is made under the premise of judgment of dependency relationship between the front and rear components to greatly reduce the search time;

4. The present invention adopts the binary table position matching method at the time of index matching, with little occupation of system space resources, and adopts a plurality of judgment principles when matching the association to improve the accuracy of the judgment.

### BRIEF DESCRIPTION OF THE DRAWINGS

Other features, objects, and advantages of the present invention will become more apparent from reading the description of non-limiting embodiments detailed with reference to the following drawings:

FIG. 1 is a data processing process chart.

FIG. 2 is a system model diagram of the present invention.

FIG. 3 is a system module relationship diagram of the present invention.

FIG. 4 is a system model diagram of the same association field of three components.

FIG. 5 is a system model diagram of different association fields of three components.

FIG. 6 is a system model diagram of a plurality of association fields of a plurality of components.

FIG. 7 is a step flow chart of a method provided by the present invention.

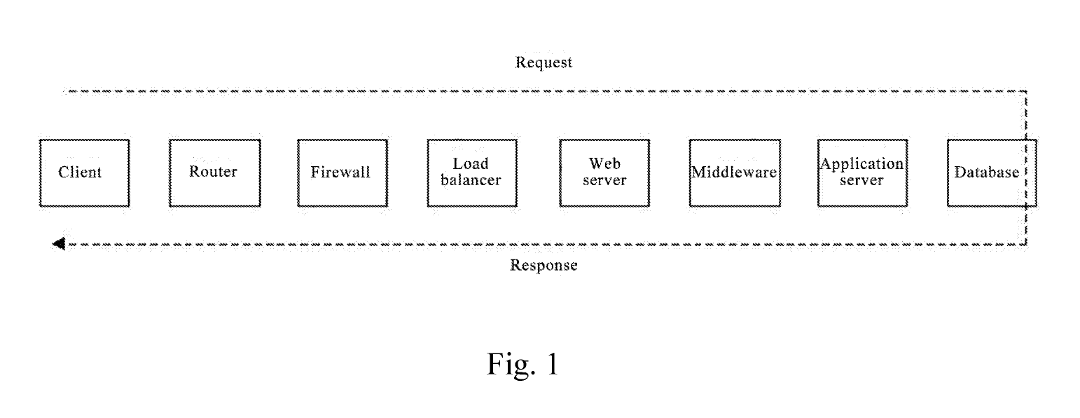

### DETAILED DESCRIPTION OF THE PREFERRED EMBODIMENT

The present invention is described in detail as follows with reference to specific embodiments. The following embodiments will help provide further understanding of the present invention for those skilled in the art, and not in any way limit the present invention. It shall be noted that several changes and improvements can be made without departing from concept of the present invention for ordinary persons skilled in the art. All these fall within the protection scope of the present invention.

A system for associating a multi-segment component transaction, provided by the present invention, comprises:

a transaction tracking record generation device which is adapted for generating transaction tracking records of each component;

a transaction information setting device which is adapted for setting association filtering parameters of a transaction to be associated, wherein the association filtering parameters comprise a starting point component;

a starting point component record filtering device which is adapted for filtering out transaction tracking records conforming to the association filtering parameters from the transaction tracking records of the starting point component; and

a non-starting point component record filtering device which is adapted for filtering out transaction tracking records matching with the filtered starting point component from the transaction tracking records of a non-starting point component,

wherein the filtered transaction tracking records of the starting point component and the non-starting point component are used as the associated multi-segment component transaction.

Preferably, the transaction tracking record generation device comprises:

an association field extraction device which is adapted for extracting association fields from each component packet respectively;

a wildcarding device which is adapted for using the association fields as wildcard fields, wherein a value of the wildcard fields is a wildcard;

a transaction information generation device which is adapted for associating a transaction request with a transaction response for each component to obtain transaction information, wherein the transaction information comprises the wildcard; and

a transaction tracking record obtaining device which is adapted for generating transaction tracking records for each component based on the transaction information.

Preferably, the association filtering parameters further comprise a search time range, a wildcard search value and a transaction delay threshold.

The starting point component record filtering device comprises:

a first filtering device which is adapted for storing transaction tracking records conforming to a condition A of the starting point component in a cache and discarding transaction tracking records not conforming to the condition A of the starting point component, wherein the condition A comprises:
a request timestamp of the transaction request in the transaction tracking records is within the search time range;
the wildcard in the transaction tracking records is consistent with the wildcard search value; and
a transaction processing time in the transaction tracking records is less than the transaction delay threshold.

Preferably, the non-starting point component record filtering device comprises:

a second filtering device which is adapted for storing transaction tracking records conforming to a condition B of the non-starting point component in the cache, and discarding transaction tracking records not conforming to the condition B of the non-starting point component, wherein the condition B comprises:
the wildcard in the transaction tracking records is consistent with the wildcard in the transaction tracking records of the starting point component;
the request timestamp of the transaction request in the transaction tracking records is later than the request timestamp of the transaction request in the transaction tracking records of the starting point component; and
the transaction processing time in the transaction tracking records is less than the transaction processing time in the transaction tracking records of the starting point component.

Preferably, the transaction tracking record obtaining device comprises:

means for generating an index number based on the wildcard, wherein the index number is a set of binary numbers; and

means for generating an index table based on the index number, wherein the index table comprises a plurality of binary query tables and the binary numbers in the index number are distributed in the plurality of binary query tables,

wherein the transaction tracking records comprise the index number and the index table.

The second filtering device comprises:

an index matching device which is adapted for matching the index number in the transaction tracking records of the starting point component with the index table in the transaction tracking records of the non-starting point component based on a distribution position of the index number of the non-starting point component in the index table; if the matching is successful, it is believed that the wildcard in the transaction tracking records of the non-starting point component is consistent with the wildcard in the transaction tracking records of the starting point component; otherwise, the wildcard in the transaction tracking records of the non-starting point component is inconsistent with the wildcard in the transaction tracking records of the starting point component.

The system for associating the multi-segment component transaction can be achieved by a method for associating the multi-segment component transaction provided by the present invention. One skilled in the art can understand the method for associating the multi-segment component transaction as a specific embodiment of the system for associating the multi-segment component transaction.

Specifically, a method for associating a multi-segment component transaction, provided by the present invention, comprises steps of:

generating transaction tracking records which comprises generating transaction tracking records of each component;

setting transaction information which comprises setting association filtering parameters of a transaction to be associated, wherein the association filtering parameters comprise a starting point component;

filtering out starting point component records which comprises filtering out transaction tracking records conforming to the association filtering parameters from the transaction tracking records of the starting point component; and

filtering out non-starting point component records which comprises filtering out transaction tracking records matching with the filtered starting point component from the transaction tracking records of the non-starting point component,

wherein the filtered transaction tracking records of the starting point component and the non-starting point component are used as the associated multi-segment component transaction.

Preferably, the step of generating transaction tracking records comprises:

extracting n association fields which comprises extracting the association fields from every component packet respectively;

performing wildcarding which comprises using the association fields as wildcard fields, wherein a value of the wildcard fields is a wildcard;

generating transaction information which comprises associating a transaction request with a transaction response for each component and obtaining the transaction information, wherein the transaction information comprises the wildcard; and

obtaining the transaction tracking records which comprises obtaining the transaction tracking records for each component based on the transaction information.

Preferably, the association filtering parameters further comprise a search time range, a wildcard search value and a transaction delay threshold.

The step of filtering out starting point component records comprises:

a first filtering step which comprises storing transaction tracking records conforming to a condition A of the starting point component in a cache and discarding transaction tracking records not conforming to the condition A of the starting point component, wherein the condition A comprises:
a request timestamp of the transaction request in the transaction tracking records is within the search time range;
the wildcard in the transaction tracking records is consistent with the wildcard search value; and
a transaction processing time in the transaction tracking records is less than the transaction delay threshold.

Preferably, the step of filtering out non-starting point component records comprises:

a second filtering step which comprises storing transaction tracking records conforming to a condition B of the non-starting point component in the cache and discarding transaction tracking records not conforming to the condition B of the non-starting point component, wherein the condition B comprises:
the wildcard in the transaction tracking records is consistent with the wildcard in the transaction tracking records of the starting point component;
the request timestamp of the transaction request in the transaction tracking records is later than the request timestamp of the transaction request in the transaction tracking records of the starting point component; and
the transaction processing time in the transaction tracking records is less than the transaction processing time in the transaction tracking records of the starting point component.

Preferably, the step of obtaining transaction tracking records comprises:

generating an index number based on the wildcard, wherein the index number is a set of binary numbers; and

generating an index table based on the index number, wherein the index table comprises a plurality of binary query tables and the binary numbers in the index number are distributed in the plurality of binary query tables,

wherein the transaction tracking records comprise the index number and the index table.

The second filtering step comprises:

performing index matching which comprises matching the index number in the transaction tracking records of the starting point component with the index table in the transaction tracking records of the non-starting point component based on a distribution position of the index number of the non-starting point component in the index table; if the matching is successful, it is believed that the wildcard in the transaction tracking records of the non-starting point component is consistent with the wildcard in the transaction tracking records of the starting point component; otherwise, the wildcard in the transaction tracking records of the non-starting point component is inconsistent with the wildcard in the transaction tracking records of the starting point component.

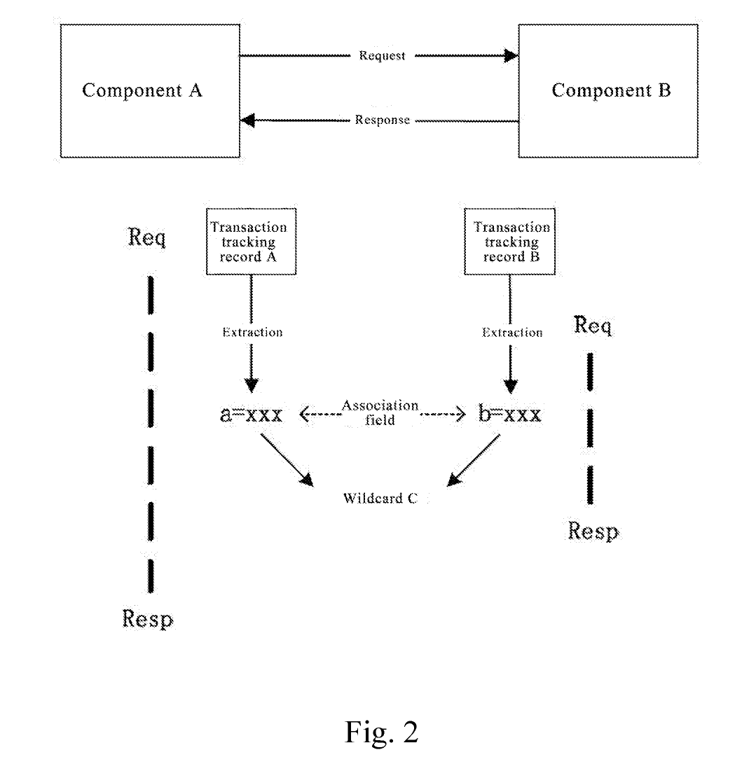

As shown in FIG. 2, a minimal model in an application of a method for associating a multi-segment component transaction according to the present invention is based on two connected components in a front and rear, namely, component A and component B.

When a specific business transaction needs to be processed in client, the data processing flow needs to comprise the following steps:

(S1) a data request first goes through component A, and component A receives the data request and then forwards the data request to component B after the data processing;

(S2) after receiving the data request, component B processes the specific transaction to generate the response data, and this transaction is completed for the component B;

(S3) Component B sends a data response to component A and this transaction is completed for component A; and

(S4) Component A sends the data response (i.e., the transaction result) to the client.

In this model, if component A does not send a data request to component B, component B cannot process the transaction, and the association field of component A can be associated with that of component B; therefore, component B relies on component A. Each component generates a transaction tracking record belonging to the component according to different message specifications and protocol configuration. For component A, the transaction tracking record is transaction tracking record A; for component B, the transaction tracking record is transaction tracking record B.

Before the transaction is associated, for the client, a transaction request is processed by component A and component B respectively, and then the processing result is got; but for the component, a transaction for component A is separate from and independent of a transaction for component B. Therefore, it is required to specify an association field for a transaction. The association field can be found in the transaction tracking records of component A and component B, such as transaction serial number, transaction type, transaction channel, and return code. In the model, association field a in transaction tracking record A and association field b in transaction tracking record B can be specified.

According to the present invention, association field a is extracted and the specific value of association field a is compared with the specific value of association field b. If the comparison result is consistent and is within the longest transaction delay, component A and Component B are associated successfully in this transaction.

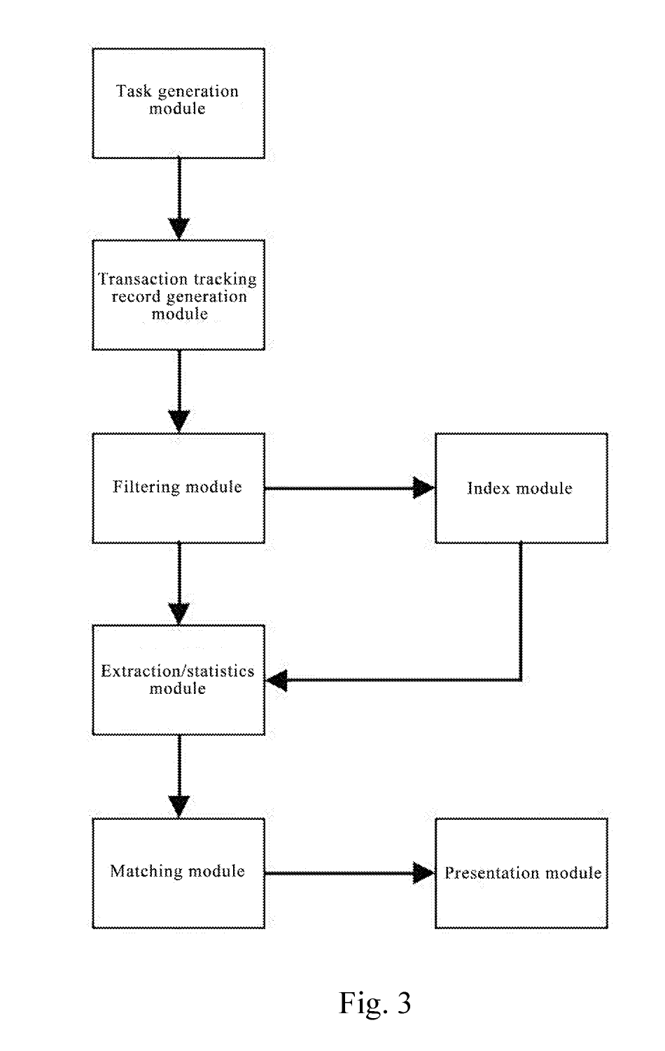

In another preferred embodiment, as shown in FIG. 3, a system for associating a multi-segment component transaction, provided by the present invention, comprises:

I. A task generation module for:

1) Setting the starting point component of the multi-segment transaction tracking task (for the minimal model, namely, component A), search time range, field required to be associated in the task (i.e., field C) and specific value (i.e., xxx); and

2) Generating the buffer memory space of the task in the system.

II. A transaction tracking record generation module for:

1) Decoding the packet of each component and obtaining the required information field according to the message specification and protocol format;

2) Using the association field of each component as a wildcard field and translating the value of the wildcard field into a wildcard C due to different names of association fields of components, for example, association field A for component A and association field B for component B;

3) Associating the request field information with the response field information in a component to generate the information of a transaction through the data flow serial number or other fields that can be paired;

4) Arranging the fields in the information of a transaction to generate a transaction tracking record and generate an index number and an index table matching with the record; and

5) Storing the transaction tracking record and the matching index table in the database (each component has its own transaction tracking record and index table).

III. A filtering module for:

1) Searching for the request timestamp field of the starting point component (component A) set for the task based on the search time range of the multi-segment association task, and retaining the transaction tracking record of the request timestamp field within the search time range and discarding the remaining;

2) Performing the second round of search in the retained transaction tracking record based on the search conditions (the association field and its specific value) of the multi-segment association task, and retaining the transaction tracking record conforming to the conditions and discarding the remaining; and

3) Putting the retained transaction tracking record in the task cache.

IV. An index module for:

1) Comparing the index tables of subsequent components in the database based on the association field value in the search result of the starting point component and the index numbers of subsequent components. For example, in the system minimal model, setting component A to the starting point component of the transaction multi-segment association and comparing the index tables of component B in the database through the specific value XXX of association field C and the index number of component B (wherein wildcard C is also the value of the association field of component B);

2) Storing the index table in binary form and providing an index table with a plurality of binary query tables;

4) When the binary numbers of field C match with all positions of binary tables in the index table of component B, it indicates that the transaction tracking record corresponding to component B matches successfully;

5) Indexing all transaction tracking records of component B, and retaining the required transaction tracking record and discarding the remaining; and

6) Putting the retained transaction tracking record in the task cache.

V. An extraction/statistics module for:

1) Extracting association field C, the request timestamp and the response timestamp in the transaction tracking record of each component in the cache; and

2) Making the statistics of the request timestamp-response timestamp to get the transaction time of each component.

VI. A matching module for:

1) Performing the matching based on the following principles:

(1) The request timestamp of the starting point component (i.e., component A) is within the search time range;

(2) A transaction for each component has the longest transaction delay; when one transaction processing time of the component is larger than the transaction delay, it is determined that the transaction is failed and not used as the record of the multi-segment transaction association;

(3) The request timestamp of component B is larger than the request timestamp of component A, that is, the request time of component B is later than that of component A;

(4) The transaction processing time of component A is larger than the transaction processing time of component B;

2) After the matching is completed, pairing the transaction tracking records of component A and component B by 1 to 1;

3) Generating a new multi-segment transaction record and putting it in the task cache;

VII. A presentation module for:

1) Reading the multi-segment transaction record information in the cache;

2) Presenting the statistical results of the multi-segment transaction association through the keyword selected by the task generation module; and

3) Presenting the results incrementally, that is, presenting the results while reading the cache.

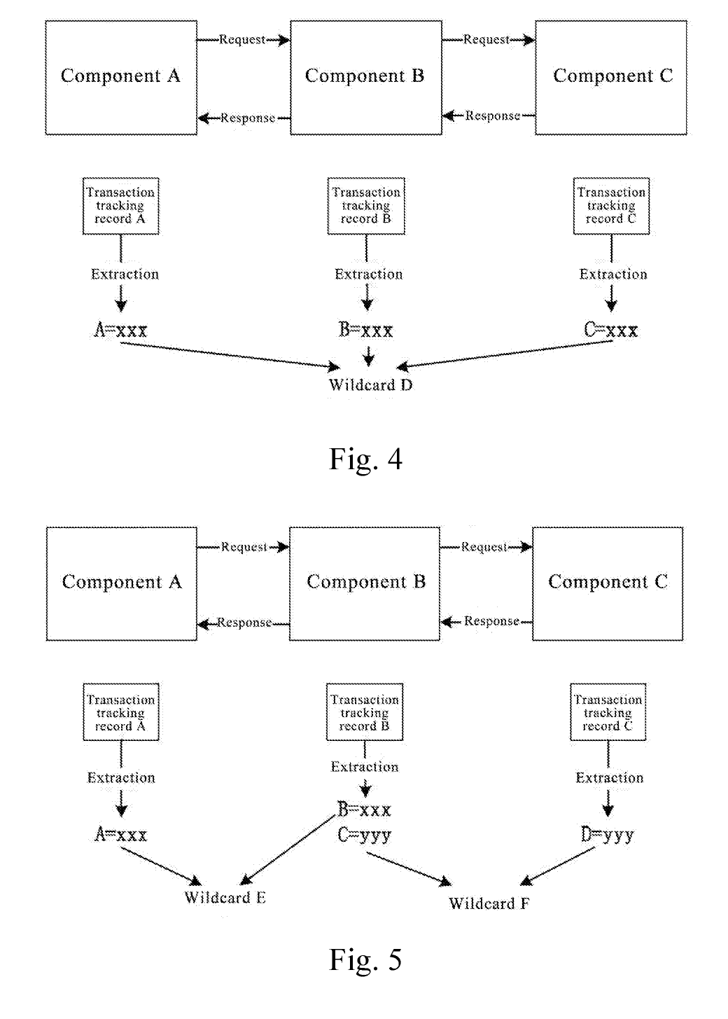

In another preferred embodiment, as shown in FIG. 4, a system for multi-segment association by three components for an association field can be derived based on a minimal system model:

wherein the client sends a business transaction request to component A, and component A receives the request and then forwards the request to component B after the data processing; component B receives the request and then forwards the request to component C after the data processing; component C processes the data and generates a response data packet. Component C sends the response data to component B, and then component B sends the response data to component A, finally component A returns the transaction processing result to the client, so that a transaction is completed.

Component B receives the data request forwarded by component A and has the same association field as that of component A; therefore, component B relies on component A. Component C receives the data request forwarded by component B and has the same association field as those of component B and component A; therefore, component C relies on component A and component B.

In addition, the values of association fields A, B and C of component A, component B and component C can be set (wildcard) to wildcard D. After component A is used as the starting point component in the multi-segment association, because component B and component C rely on component A, the system steps as shown in FIG. 3 are started at the same time and the search result is finally obtained.

In another preferred embodiment, as shown in FIG. 5, a system for multi-segment association by three components for two association fields can be derived based on a minimal system model:

wherein the process from sending a business transaction request by the client to component A, component B and component C to the completion of a transaction is consistent with FIG. 4. Component B receives the data request forwarded by component A and has the same association field as that of component A; therefore, component B relies on component A. Component C receives the data request forwarded by component B and has the same association field as that of component B (the same association field refers to the same value of the association field); therefore, component C relies on component B. In addition, the values of association fields A and B of component A and component B can be set (wildcard) to wildcard E; the values of association fields C and D of component B and component C can be wildcard to wildcard F. After component A is used as the starting point component in the multi-segment association, because component B relies on component A, the system steps as shown in FIG. 3 are started; because component C relies on component B, the system steps as shown in FIG. 3 are started after component B receives the data request; finally, the system synthesizes the search results of component A-component B and component B-component C to obtain the final processing result.

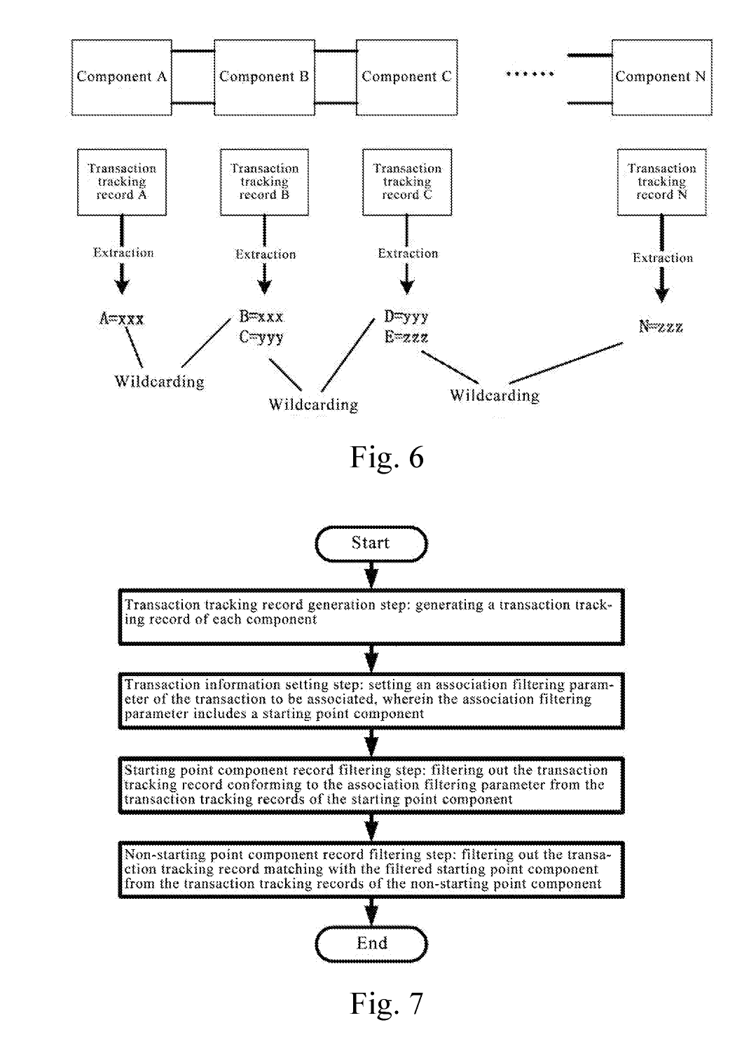

In another preferred embodiment, as shown in FIG. 6, a system for multi-segment association by a plurality of components for a plurality of association fields can be derived based on a minimal system model and the systems as shown in FIGS. 4 and 5:

wherein the process from sending a business transaction request by the client to component A, component B, component C . . . and component N to the completion of a transaction is consistent with FIGS. 4 and 5. Component B receives the data request forwarded by component A and has the same association field as that of component A; therefore, component B relies on component A. Component C receives the data request forwarded by component B and has the same association field as that of component B; therefore, component C relies on component B, and so on. In addition, association fields A and B of component A and component B can be wildcard to wildcards; association fields C and D of component B and component C can be wildcard to wildcards; association fields E and N of component C and component N can be wildcard to wildcards. After component A is used as the starting point component in the multi-segment association, because component B relies on component A, the system steps as shown in FIG. 3 are started; because component C relies on component B, the system steps as shown in FIG. 3 are started after component B receives the data request; because component N relies on component C, the system steps as shown in FIG. 3 are started after component C receives the data request; finally, the system synthesizes the search results of component A-component B, component B-component C . . . and component C-component N to obtain the final processing result.

It can be seen that the result of the multi-segment transaction association can be calculated accurately and quickly for multiple components through the time range and the setting of multiple association fields and presented in front of the operators according to the present invention.

It will be appreciated by those skilled in the art that, in addition to implementing the system and various devices provided by the present invention by purely computer-readable program code mode, the system and various devices provided by the present invention can achieve the same function in the form of logic gates, switches, special integrated circuit, programmable logic controller and microcontrollers by logically programming the method steps. Therefore, the system and various devices provided by the present invention may be considered as a kind of hardware component; the device for implementing various functions included therein may also be considered as a structure within a hardware component; the device for implementing various functions may be considered as a software module for implementing the method and a structure within the hardware component.

Specific embodiments of the present invention are described above. It shall be understood that the present invention is not limited to the above-mentioned specific embodiments, and those skilled in the art can make various changes and modifications within the scope of the claims, and it shall not affect the substance of the present invention. In the absence of a conflict, embodiments of the present application can be arbitrarily combined with features in the embodiments.

What is claimed is:

1. A method for associating a multi-segment component transaction, comprising steps of:
generating transaction tracking records which comprises generating transaction tracking records of each component;
setting transaction information which comprises setting association filtering parameters of a transaction to be associated, wherein the association filtering parameters comprise a starting point component;
filtering out starting point component records which comprises filtering out transaction tracking records conforming to the association filtering parameters from the transaction tracking records of the starting point component;
filtering out non-starting point component records which comprises filtering out transaction tracking records matching with the filtered starting point component from the transaction tracking records of a non-starting point component,
wherein the filtered transaction tracking records of the starting point component and the non-starting point component are used as the associated multi-segment component transaction.

2. The method for associating the multi-segment component transaction according to claim 1, wherein the step of generating transaction tracking record comprises:
extracting association fields which comprises extracting the association field from each component packet respectively;
performing wildcarding which comprises using the association fields as wildcard fields, wherein a value of the wildcard fields is a wildcard;
generating transaction information which comprises associating a transaction request with a transaction response for each component to obtain the transaction information, wherein the transaction information comprises the wildcard; and
obtaining the transaction tracking record for each component based on the transaction information.

3. The method for associating the multi-segment component transaction according to claim 2, wherein the association filtering parameters further comprise a search time range, a wildcard search value and a transaction delay threshold;
the step of filtering out starting point component records comprises:
a first filtering step which comprises storing transaction tracking records conforming to a condition A of the starting point component in a cache and discarding transaction tracking records not conforming to the condition A of the starting point component, wherein the condition A comprises:
a request timestamp of the transaction request in the transaction tracking records is within the search time range;
the wildcard in the transaction tracking records is consistent with the wildcard search value; and
a transaction processing time in the transaction tracking records is less than the transaction delay threshold.

4. The method for associating the multi-segment component transaction according to claim 3, wherein the step of filtering out non-starting point component record comprises:
a second filtering step which comprises storing transaction tracking records conforming to a condition B of the non-starting point component in the cache and discarding transaction tracking records not conforming to the condition B of the non-starting point component, wherein the condition B comprises:
the wildcard in the transaction tracking records is consistent with the wildcard in the transaction tracking records of the starting point component;
the request timestamp of the transaction request in the transaction tracking records is later than the request timestamp of the transaction request in the transaction tracking records of the starting point component; and
the transaction processing time in the transaction tracking records is less than the transaction processing time in the transaction tracking records of the starting point component.

5. The method for associating the multi-segment component transaction according to claim 4, wherein the step of obtaining transaction tracking record comprises:
generating an index number based on the wildcard, wherein the index number is a set of binary numbers; and
generating an index table based on the index number, wherein the index table comprises a plurality of binary query tables and the binary numbers in the index number are distributed in the plurality of binary query tables,
wherein the transaction tracking records comprise the index number and the index table,
the second filtering step comprises:
performing index matching which comprises matching the index number in the transaction tracking records of the starting point component with the index table in the transaction tracking records of the non-starting point component based on a distribution position of the index number of the non-starting point component in the index table; if the matching is successful, it is believed that the wildcard in the transaction tracking records of the non-starting point component is consistent with the wildcard in the transaction tracking records of the starting point component; otherwise, the wildcard in the transaction tracking records of the non-starting point component is inconsistent with the to wildcard in the transaction tracking records of the starting point component;
wherein the transaction tracking records comprises at least one member selected from a group consisting of:
transaction time;
type; and
serial number.

6. A system for associating a multi-segment component transaction, comprising:
a transaction tracking record generation device which is adapted for generating transaction tracking records of each component;
a transaction information setting device which is adapted for setting association filtering parameters of a transaction to be associated, wherein the association filtering parameters comprise a starting point component;
a starting point component record filtering device which is adapted for filtering out transaction tracking records conforming to the association filtering parameters from the transaction tracking records of the starting point component; and
a non-starting point component record filtering device which is adapted for filtering out transaction tracking records matching with the filtered starting point component from the transaction tracking records of the non-starting point component,
wherein the filtered transaction tracking records of the starting point component and the non-starting point component are used as the associated multi-segment component transaction.

7. The system for associating the multi-segment component transaction according to claim 6, wherein the transaction tracking record generation device comprises:
an association field extraction device which is adapted for extracting association fields from each component packet respectively;
a wildcarding device which is adapted for using the association fields as wildcard fields, wherein a value of the wildcard fields is a wildcard;
a transaction information generation device which is adapted for associating a transaction request with a transaction response for each component and obtaining the transaction information, wherein the transaction information comprises the wildcard; and
a transaction tracking record obtaining device which is adapted for obtaining the transaction tracking records for each component based on the transaction information.

8. The system for associating the multi-segment component transaction according to claim 7, wherein the association filtering parameters further comprise a search time range, a wildcard search value and a transaction delay threshold;
the starting point component record filtering device comprises:
a first filtering device which is adapted for storing transaction tracking records conforming to a condition A of the starting point component in a cache and discarding transaction tracking records not conforming to the condition A of the starting point component, wherein the condition A comprises:
a request timestamp of the transaction request in the transaction tracking records is within the search time range;
the wildcard in the transaction tracking records is consistent with the wildcard search value; and
a transaction processing time in the transaction tracking records is less than the transaction delay threshold.

9. The system for associating the multi-segment component transaction according to claim 8, wherein the non-starting point component record filtering device comprises:
a second filtering device which is adapted for storing transaction tracking records conforming to a condition B of the non-starting point component in the cache and discarding transaction tracking record not conforming to the condition B of the non-starting point component, wherein the condition B comprises:
the wildcard in the transaction tracking records is consistent with the wildcard in the transaction tracking records of the starting point component;
the request timestamp of the transaction request in the transaction tracking records is later than the request timestamp of the transaction request in the transaction tracking records of the starting point component; and
the transaction processing time in the transaction tracking records is less than the transaction processing time in the transaction tracking records of the starting point component.

10. The system for associating the multi-segment component transaction according to claim 9, wherein the transaction tracking record obtaining device comprises:
means for generating an index number based on the wildcard, wherein the index number is a set of binary numbers; and
means for generating an index table based on the index number, wherein the index table comprises a plurality of binary query tables and the binary numbers in the index number are distributed in the plurality of binary query tables;
wherein the transaction tracking records comprise the index number and the index table,
the second filtering device comprises:
an index matching device which is adapted for matching the index number in the transaction tracking records of the starting point component with the index table in the transaction tracking records of the non-starting point component based on the distribution position of the index number of the non-starting point component in the index table; if the matching is successful, it is believed that the wildcard in the transaction tracking records of the non-starting point component is consistent with the wildcard in the transaction tracking records of the starting point component; otherwise, the wildcard in the transaction tracking records of the non-starting point component is inconsistent with the wildcard in the transaction tracking records of the starting point component;
wherein the transaction tracking records comprises at least one member selected from a group consisting of:
transaction time;
type; and
serial number.
